(19) United States
(12) Patent Application Publication
(10) Pub. No.: US 2026/0159423 A1
(43) Pub. Date: Jun. 11, 2026

(54) METHODS FOR MONITORING TAGGED ORGANIC COAGULANT POLYMERS IN WATER TREATMENT SYSTEMS

(71) Applicant: CHEMTREAT, INC., Glen Allen, VA (US)

(72) Inventors: Vladimir Djukanovic, Glen Allen, VA (US); Naresh N. Mahamuni, Henrico, VA (US); Rebecca Walker, Mechanicsville, VA (US)

(73) Assignee: CHEMTREAT, INC., Glen Allen, VA (US)

(21) Appl. No.: 19/408,892

(22) Filed: Dec. 4, 2025

Related U.S. Application Data
(60) Provisional application No. 63/730,182, filed on Dec. 10, 2024.

(51) Int. Cl. C02F 1/52; C02F 1/44; C02F 3/12

(52) U.S. Cl. CPC C02F 1/5209; C02F 1/441; C02F 1/444; C02F 1/5272; C02F 3/1268

(57) ABSTRACT

A method of monitoring tagged poly-DADMAC in a water treatment system includes adding an initial amount of the tagged poly-DADMAC into the water treatment system to obtain a target concentration of the poly-DADMAC in the water treatment system; and measuring a later concentration of the poly-DADMAC in the water treatment system. Another method of monitoring tagged poly-DADMAC in a water treatment system includes continuously adding the tagged poly-DADMAC into the water treatment system at an initial position within the water treatment system; continuously measuring a downstream concentration of the poly-DADMAC within the water treatment system; determining whether the measured downstream concentration is above or below a predetermined threshold value; and adjusting a concentration of the poly-DADMAC being continuously added into the water treatment system according to whether the measured downstream concentration is determined to be above or below the predetermined threshold value.

### BACKGROUND

A number of organic water treatment additives have been developed for various applications in water treatment systems, such as for treatment of municipal wastewater, industrial wastewater, and landfill leachate. For example, organic coagulant polymers, and particularly cationic polymers such as poly(diallyldimethylammonium chloride) (poly-DADMAC), can be used as a process additive in water treatment applications, most commonly as coagulants.

Few reliable methods currently exist for the detection and quantification of organic coagulant polymers in water systems. For example, the Hach QAC Method (8337 Direct Binary Complex Method) uses two reagents and is very difficult to administer and is subject to inaccuracies resulting from, for example, noise from cloudy water. It also suffers from much interference that makes rapid and accurate measurements difficult. Moreover, existing methods often suffer from interference associated with common ions including, for example, ions of calcium, chlorine, magnesium, and iron. Other compounds that can interfere with detection and quantification of organic coagulant polymers include compounds associated with common surfactants and treatment compounds such as, for example, sodium lauryl sulfate and sodium polyphosphate. These interferences limit the usefulness of detection and quantification methods, particularly when the goal is to perform rapid and accurate measurements of the organic coagulant polymer.

Current methods for monitoring organic coagulant polymers are therefore somewhat inaccurate, and often result in over-feeding of the polymer. Nevertheless, these current methods have been considered to be satisfactory according to industry standards. To date, these issues with prompt and accurate monitoring of organic coagulant have not been addressed.

### SUMMARY

The inventors discovered that the rapid and accurate detection and quantification of organic coagulant polymers is particularly important in certain types of water-treatment applications.

For example, cationic polymers are sometimes used to treat water systems in a membrane bioreactor (MBR). However, the inventors found that there are certain unique issues with using cationic polymers to treat water in MBR applications, such as biomass toxicity, negative environmental impact, and membrane compatibility.

Furthermore, in applications using reverse osmosis membranes, the inventors found that overfeeding cationic polymers can result in fouling of the membrane (and the same potential negative environmental impact).

Having sought to address these previously unrecognized issues, the inventors developed methods of rapidly and accurately measuring the amount of organic coagulant polymer. The methods can be performed real-time, allowing for immediate adjustment to the administration of the organic coagulant polymer. The methods have a particularly advantageous impact on the operation of membrane bioreactors and reverse osmosis systems.

### BRIEF DESCRIPTION OF THE DRAWINGS

FIG. 1 is a schematic diagram of a submerged membrane bioreactor.

FIG. 2 is a schematic diagram of a side stream membrane bioreactor.

FIG. 3 is a schematic diagram of a multistage reverse osmosis system.

FIG. 4 is a graph depicting the relationship between a measured amount of fluorescently tagged poly-DADMAC in a water system (as measured using fluorometry), and the added active amount of fluorescently labeled poly-DADMAC in the water treatment system.

FIG. 5 is a graph depicting the relationship between a measured amount of fluorescently tagged poly-DADMAC in a water system (as measured using fluorometry), and the added active amount of fluorescently labeled poly-DADMAC in the water treatment system.

It should be noted that these figures are intended to illustrate the general characteristics of methods with reference to certain example embodiments of the invention and thereby supplement the detailed written description below.

### DETAILED DESCRIPTION OF EMBODIMENTS

As described herein, methods are provided for monitoring the amount of organic coagulant polymers in water systems.

As used herein, an “organic coagulant polymer” is any organic polymer that functions to coagulate suspended particles in water, allowing for their precipitation and separation from the water. The polymers may be anionic, cationic, or nonionic. Cationic polymers are particularly well suited for coagulation and separation of suspended particles in water.

### Cationic Polymers

Cationic polymers ionize in water to form positively charged sites along the polymer molecule, and are sometimes used in water treatment to remove suspended solids. The positively charged positions of the polymer attract and neutralize negative charges of particles that are suspended in the water. When brought together, the particles coagulate and form a much larger mass, which then precipitates out of the water.

Examples of suitable cationic polymers for water treatment applications include polyamines and poly-DADMAC.

### Polyamines

Polyamines have the chemical structure shown below, and can be either naturally occurring or synthetic.

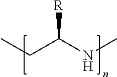

Examples of naturally occurring polyamines include:

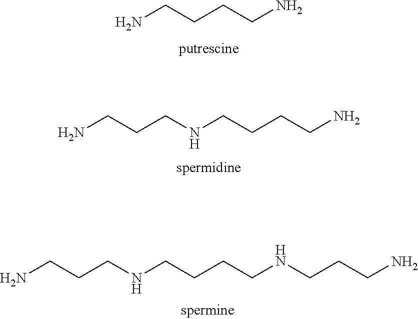 [SMILES: NCCCCN ; NCCCCNCCCN ; NCCCNCCCCNCCCN]

Other examples of suitable polyamines include cationic quaternary amine polymers, such as polydimethylamine.

### Poly-DADMAC

Poly-DADMAC is a high charge density cationic polymer. The high charge density makes it well suited for coagulation because the poly-DADMAC will neutralize negatively charged colloidal material and reduce sludge volume. Poly-DADMAC is effective in coagulating inorganic and organic particles such as silt, clay, algae, bacteria, and viruses.

Poly-DADMAC is a homopolymer of diallyldimethylammonium chloride (shown in the chemical formula below), and its molecular weight is typically in the range of hundreds of thousands to a million grams per mole.

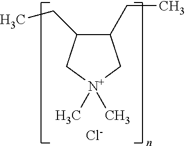

Poly-DADMAC is water soluble, and is usually stored in the form of a liquid concentrate with a solids/active content ranging from 10 to 50 wt %.

Poly-DADMAC is not classified as a hazardous material, but prolonged exposure to poly-DADMAC can cause irritation to the eyes, skin, and respiratory system. And while its presence in water system effluent is generally of minor environmental concern, it can have a significant impact on aquatic life, particularly after chronic exposure. Accordingly, it is important to monitor the amount of poly-DADMAC in a water treatment system in order to ensure that over-feeding does not result in chronic exposure of aquatic life to excess poly-DADMAC in the effluent (which is usually disposed into natural waterways).

### Methods of Monitoring Cationic Polymers

The disclosed embodiments include methods for monitoring an amount of cationic polymers in water systems. In such systems, the cationic polymer may have been introduced to the water system within a range of suitable concentrations depending on the application. The concentration of cationic polymer can be adjusted depending on the residual anionic charge in the water, which will depend on the application.

For example when poly-DADMAC is used, it can be added so that the concentration of poly-DADMAC in the water is initially in the range of 0.05 ppm to 500 ppm, 0.08 ppm to 300 ppm, 0.1 ppm to 250 ppm, 0.5 ppm to 150 ppm, or 1 ppm to 100 ppm as active poly-DADMAC. Herein, “active poly-DADMAC” refers to the functional portion of the poly-DADMAC chemistry that impacts the water treatment process. The proportion of active poly-DADMAC can range from 0.1% to 100% of the formulation, depending on the product; poly-DADMAC is usually 25% to 50% active.

The cationic polymer can be added continuously, periodically on a schedule, or intermittently only as needed. In any of these cases, the amount of cationic polymer that is being added can be adjusted to provide the optimum concentration of cationic polymer in the system without overfeeding. For example, the amount of cationic polymer added to the system can be adjusted by controlling the feed rate of the cationic polymer, either by adjusting the flow rate of the continuous addition of the cationic polymer, controlling the frequency with which the cationic polymer is administered, and/or by adjusting the amount or concentration of the cationic polymer being added at each administration. These adjustments can be performed either manually or through an automated process in response to a measurement indicating that the amount of cationic polymer currently in the system should be increased or decreased.

In the disclosed embodiments, the cationic polymer can be tagged with a detectable marker in order to facilitate monitoring. For example, the cationic polymer can be tagged with a fluorescent or colorimetric marker that can be monitored. Examples of suitable markers include carbocyanines, benzopyryliums, xanthene, difluroboron complexes, rhodamine-B esters, succinimidyl ester of 7-(diethylamino) coumarin-3-carboxyllic acid, 1,3,6,8-pyrenetetrasulfonic acid sodium salt, 8-hydroxy-1,3,6-pyrene trisulfonic acid sodium salt, pyrenesulfonic acid (mono) sodium salt, fluorescein, 4-methoxy-N-(3-N′,N′-dimethylaminopropyl) naphthalimide, vinyl benzyl chloride quaternary salt (4-MNDMAPN-VBQ); 4-methoxy-N-(3-N′,N′-dimethylaminopropyl) naphthalimide, allyl chloride quaternary salt (4-MNDMAPN-AQ), 4-methoxy-N-(3-N′,N′-dimethylaminopropyl) naphthalimide, 2-hydroxy-3-allyloxypropyl quaternary salt (4-MNDMAPN-HAPQ), N-allyl-4-(2-N′,N′-dimethylaminoethoxy) naphthalimide, methyl sulfate quaternary salt (4-NADMAEN-MSQ), 5-allyloxy-4′-carboxy-1,8 naphthoylene-1′, 2′-benzimidazole (5-ACNB), 6-vinylbenzyloxy-4′-carboxyl-1,8-naphthoylene-1′, 2′-benzimidazole (6-VBCNB), and N,N-dimethyl-N-[3-[N′-(4-methoxy naphthalimide)]]propyl-N-(2-hydroxy-3-allyloxy) propyl ammonium hydroxide.

In one embodiment, the cationic polymer is tagged before being introduced into the system. The amount of the cationic polymer can then be monitored either through sampling and analysis, or using online sensors. The monitoring can be continuous, intermittently as needed, or according to regular periodic intervals. For example, in the case where the cationic polymer is tagged with a fluorescent marker, the amount of the cationic polymer can be continuously monitored real-time using a fluorometer, which can measure the amount of marker present in the system using fluorescence spectroscopy. The fluorometer, or other appropriate sensor depending on the type of marker, can be positioned in-line with the system at any position at which it is desirable to measure the amount of the cationic polymer present. Several sensors can be positioned at different locations to monitor the distribution of the cationic polymer throughout the system. Thus, the amount of poly-DADMAC can be measured in situ. Here, “in situ” measurement means that the measurement was performed within the system itself, and optionally during operation, without requiring that a sample be obtained.

The type of fluorescent probe used to perform fluorometry is not particularly limited. Suitable examples include:

### Handheld Probe:

SP-380P (PTSA and fluorescent polymer handheld fluorometer), Pyxis, Inc.
SP-350P (fluorescent polymer handheld fluorometer), Pyxis, Inc. with excitation wavelength 410 nm and emission wavelengths 450 nm-470 nm

### Inline Probe:

ST-590 (inline tagged polymer sensor), Pyxis, Inc. with excitation wavelength 410 nm and emission wavelength 450 nm

### Tabletop Probe:

RF-6000 (spectrofluorophotometer), Shimadzu Scientific Instruments with wavelength range up to 900 nm

The disclosed methods could further include a step of determining whether the amount of the cationic polymer being added into the system should be adjusted according to any of the methods described above, based on the measured amount of the cationic polymer in the water.

For example, it could be determined that the amount of the cationic polymer being added should be increased if the measured amount is below a predetermined minimum threshold, or decreased if the measured amount is above a predetermined maximum threshold. The minimum threshold can be, for example, 0.05 ppm, 0.08 ppm, 0.1 ppm, 0.3 ppm, 0.5 ppm, 0.6 ppm, 0.8 ppm, 1.0 ppm, or 1.5 ppm. The maximum threshold can be, for example, 1 ppm, 3 ppm, 5 ppm, 8 ppm, 10 ppm, 25 ppm, 50 ppm, 75 ppm, or 100 ppm. Example threshold concentrations of excess poly-DADMAC in water include:
a minimum of 0.1 ppm poly-DADMAC in feedwater in reverse osmosis applications
a minimum of 0.1 ppm poly-DADMAC in direct discharge effluent waters
a minimum of 0.1 ppm and a maximum of 50 ppm for membrane bioreactor applications
a minimum of 0.5 ppm and a maximum of 5 ppm for cooling tower applications

The threshold values will depend to some extent on where in the system the cationic polymer concentration is being monitored, as discussed below.

The disclosed methods could further include a step of adjusting the amount of the cationic polymer being added into the system based on the determination.

The inventors found that the ability to conduct rapid and accurate monitoring of the cationic polymer, and in particular real-time and continuous monitoring, is especially advantageous in certain applications. Such advantages, and the problems they address, were heretofore unrecognized.

For example, the disclosed methods have a particularly advantageous impact on the operation of membrane bioreactors and reverse osmosis systems, direct discharge effluent streams, and cooling tower makeup water streams among other systems in which overfeeding of cationic polymers, and poly-DADMAC in particular, can lead to particularly undesirable consequences.

### Membrane Bioreactor Process

Bioreactors are commonly used in the wastewater treatment process in a process called conventional activated sludge (CAS) treatment. During CAS treatment, wastewater is mixed with bacteria in a tank (the bioreactor). The bacteria feed on organic compounds present in the water, breaking them down in the process. The solids, or activated sludge, are then pumped to a settling tank (clarifier) where they settle, separating them from the treated wastewater. Some activated sludge can be returned to the aeration tank to maintain the microbial population, ensuring a continuous supply of microorganisms to the system.

The bioreactor is a specifically designed chamber used to support a biologically active environment, where bacteria and protozoa (in the form of a biomass) can grow and consume substances within the wastewater. The bioreactor can be aerobic (to remove organic matter and oxidize ammonia to nitrate), anoxic (to remove nitrogen from nitrates to nitrogen gas), or anaerobic (to remove organic matter), depending on the presence of oxygen and nitrates or their absence.

Membranes can be installed after the bioreactor, typically in the case of aerobic or anaerobic bioreactors. In this case, the bioreactor is known as a membrane bioreactor (MBR).

In the MBR process, instead of the water being separated from the sludge in a settling tank, it is passed through filter membranes with fine pores that trap the suspended solids and allow the clean water to pass through. The membranes therefore act as a solid-liquid separation device, keeping the biomass within the bioreactor before discharging the treated effluent. MBR technology is designed to enhance the efficiency of the CAS process by using filtration membranes to achieve efficient solids separation and high effluent quality.

Both micro-(MF) and ultrafiltration (UF) membranes can be used in MBR applications. UF membranes are more typically used because of their superior separation characteristics (capable of removing some colloids and viruses as well) and lower fouling tendency (having a lower risk of pore clogging due to smaller pore size).

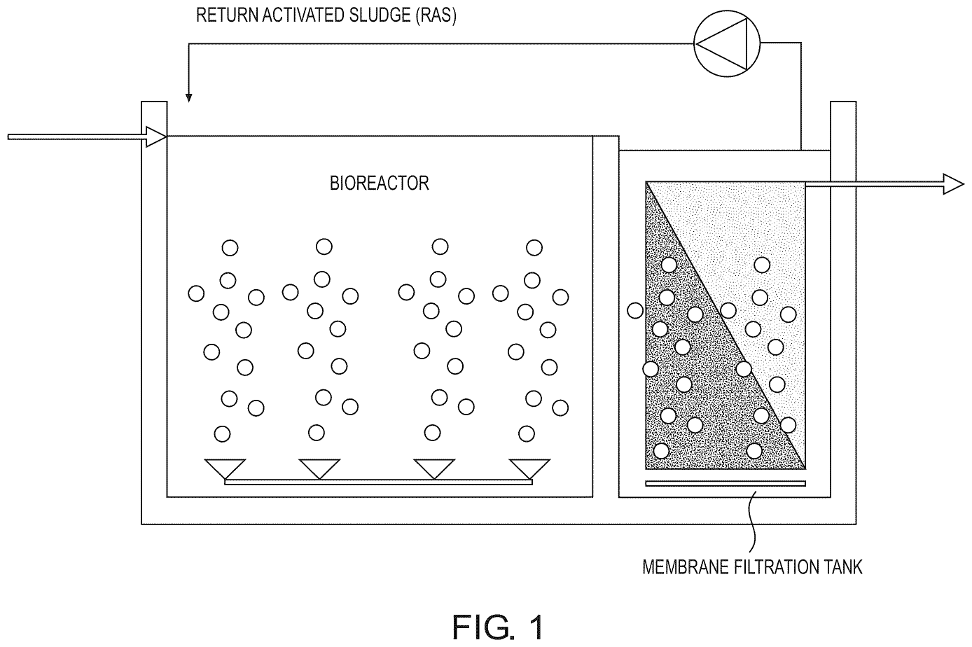

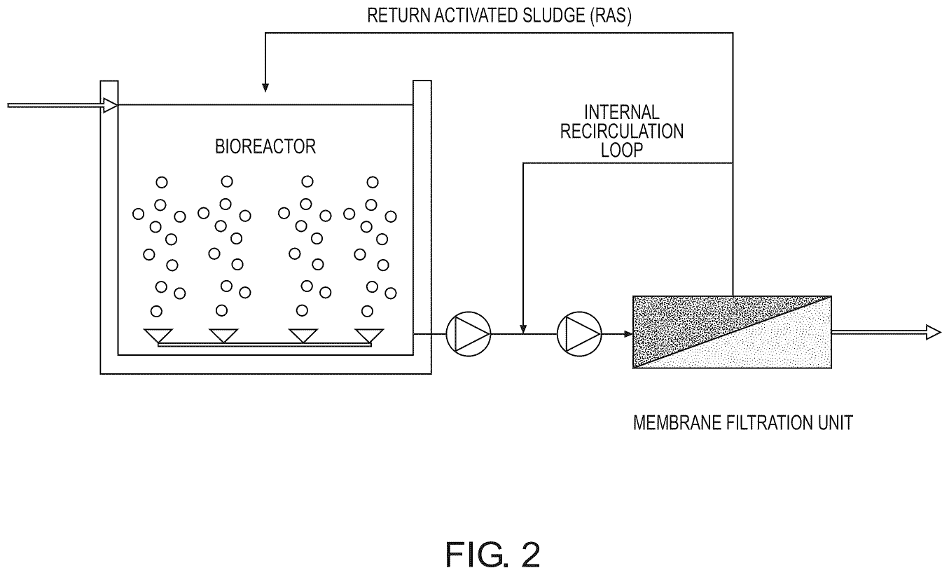

Examples of MBR systems are shown schematically in FIGS. 1 and 2.

FIG. 1 is a schematic diagram of a “submerged” MBR. In a submerged MBR, the membranes are submerged in the biomass, either inside the bioreactor itself or in a separate tank. Filtration takes place by applying vacuum to the inside of the membrane.

FIG. 2 is a schematic diagram of a “side stream” MBR. In a side stream MBR, the biomass is pumped through membrane modules in a filter installation that is set up next to the bioreactor. The membrane modules are placed in a pressurized circulation loop located outside of the bioreactor.

The effluent from the MBR process is free of suspended solids and has reduced bacterial and viral content compared to CAS process. Therefore, minimum disinfection is required compared to other wastewater treatment methods, such as the conventional activated sludge process. The MBR process can therefore allow for the treated effluent to be discharged to sensitive receiving bodies or to be reclaimed for applications such as urban irrigation, utilities, or toilet flushing. The effluent is also of sufficiently high quality that it can be fed directly to a reverse osmosis process, which is discussed in further detail below.

Cationic polymers can be used to reduce sludge volume in an MBR system. However, overfeeding of the cationic polymer in the MBR process raises at least two distinct issues that are unique to the MBR process and that have so far not been addressed by others.

First, excess cationic polymer in the MBR system can lead to membrane fouling, hampering the performance of the MBR system. This is particularly problematic when using poly-DADMAC (perhaps due to the large size and charge of the poly-DADMAC). Once fouling begins, it must be addressed by replacing the membranes, which is costly and results in system downtime and loss of production. Membrane replacement could also void any product warranties that are in place for the MBR system. Thus, the amount of the cationic polymer should be monitored to ensure that it does not increase above a threshold value at which membrane fouling begins, because the amount of cationic polymer is directly proportional to the amount of solids present in the system (the higher the amount of cationic polymer, the higher the amount of solids).

Second, excess cationic polymer in the MBR system can be toxic to the biomass. If the excess poly-DADMAC kills the biomass or otherwise reduces its size and/or compromises its capability to break down organic matter in the water, then the MBR will not efficiently treat the water entering the system. Accordingly, the amount of the cationic polymer should be monitored to ensure that it does not increase above a threshold value at which the cationic polymer becomes cytotoxic, killing cells within the biomass.

For example in order to avoid issues with fouling and toxicity, excess poly-DADMAC levels in the MBR system should be retained at less than 100 ppm, less than 70 ppm, less than 50 ppm, less than 30 ppm, less than 20 ppm, or less than 10 ppm, for example, depending upon application, in order to avoid, prevent, or reduce the progression of fouling or the likelihood of killing cells within the biomass.

The cationic polymer can be introduced and/or monitored at various positions throughout the MBR system, such as in the MBR tank and at the discharge. For example, excess poly-DADMAC concentration may be measured in the MBR tank. In this case, the maximum threshold value of excess poly-DADMAC may be, for example, 100 ppm, 70 ppm, 50 ppm, 30 ppm, 20 ppm, or 10 ppm. If the excess poly-DADMAC concentration is measured at the discharge, then the maximum threshold value of excess poly-DADMAC may be, for example, 1 ppm, 0.5 ppm, 0.2 ppm, 0.1 ppm, 0.08 ppm, or 0.05 ppm, depending upon application.

### Reverse Osmosis Process

The reverse osmosis (RO) process is a water treatment process that removes contaminants from water by using pressure to force water molecules through a semipermeable membrane. During this process, the contaminants are filtered out and flushed away, leaving clean water.

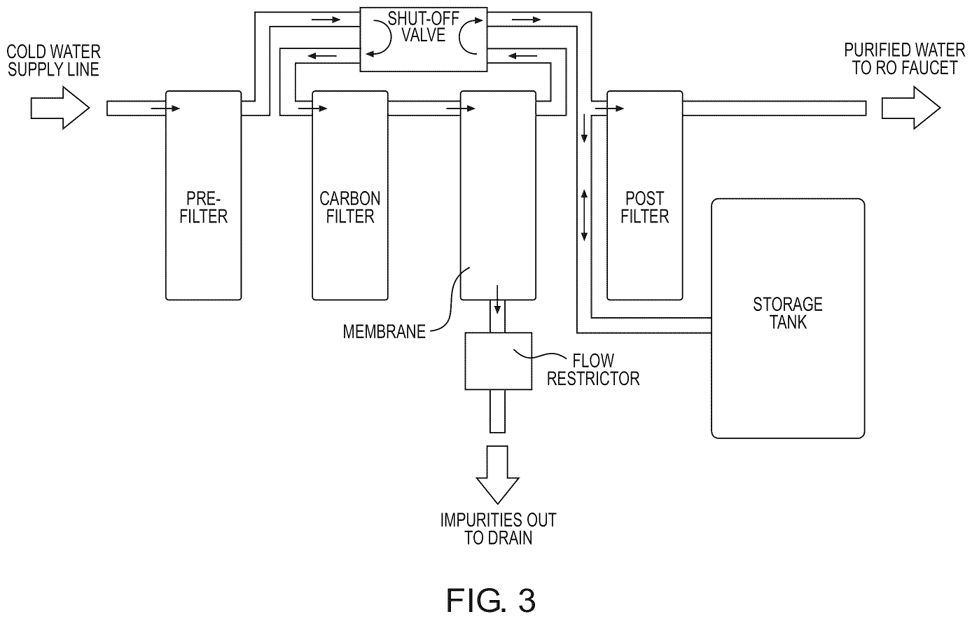

The RO process can be a multistage process. For example, the water can first undergo a pre-filter stage in which a sediment filter is used to strain out sediment, silt, and dirt. The water can then progress through a carbon filter that is designed to remove chlorine and other contaminants. The water can next proceed to the RO membrane, which is designed to allow water through but filter out almost all additional contaminants. The RO membrane can remove most impurities down to 0.001 μm in size. If needed, the water can then go through a final carbon filter that can remove any remaining content that could affect taste and odor (for example, for purposes of filtering drinking water). An example of a multistage RO system is shown schematically in FIG. 3.

Cationic polymers can be administered to reduce sludge volume in an RO system. However, overfeeding of the cationic polymer in the RO process raises at least two distinct issues that are unique to the RO process and that have so far not been addressed by others.

First, excess cationic polymer in the RO system can lead to membrane fouling (due to blinding of the RO membrane when the cationic polymer attaches to the RO membrane), hampering the performance of the RO system (similar to the MBR process discussed above). Once fouling begins, it must be addressed by replacing the membranes, which is costly and results in system downtime. Membrane replacement could also void any product warranties that are in place for the RO system. Thus, the amount of the cationic polymer should be monitored to ensure that it does not increase above a threshold value at which membrane fouling begins.

Second, excess cationic polymer that remains in the effluent that passes from the RO system can be introduced into natural waterways, posing an environmental concern. Cationic polymers can have a significant impact on aquatic life, particularly after chronic exposure. Thus, the amount of the cationic polymer should be monitored to ensure that it does not increase above a threshold value at which the effluent stream becomes toxic to aquatic life.

In order to avoid issues with fouling and negative environmental impact when using poly-DADMAC, excess poly-DADMAC levels in the RO system should be retained at less than 5 ppm, less than 1 ppm, less than 0.5 ppm, less than 0.3 ppm, less than 0.1 ppm, less than 0.05 ppm, or less than 0.03 ppm, for example, depending upon application, in order to avoid, prevent, or reduce the progression of fouling or the likelihood of causing environmental harm.

The cationic polymer can be introduced and/or monitored at various positions throughout the RO system, such as before a pretreatment system present in the RO system (e.g., a multimedia filter, microfiltration system (MF), or ultrafiltration (UF) system), or in the reject stream of the RO system. For example, excess poly-DADMAC concentration may be measured before a pretreatment system. In this case, the maximum threshold value of excess poly-DADMAC may be, for example, 100 ppm, 70 ppm, 50 ppm, 30 ppm, 20 ppm, or 10 ppm. If the excess poly-DADMAC concentration is measured in the reject stream, then the maximum threshold value of excess poly-DADMAC may be, for example, 1 ppm, 0.5 ppm, 0.2 ppm, 0.1 ppm, 0.08 ppm, or 0.05 ppm, depending upon application.

It is noted that the foregoing methods are not limited to cationic polymers, and any organic coagulant polymer may be used as long as it can be tagged and monitored.

### EXAMPLES

The following experiments were performed to demonstrate the effectiveness of the disclosed methods, and particularly the ability to accurately detect and measure the amount of cationic polymer in a water treatment system. Poly-DADMAC was used as an example.

### Example 1

The experiment of Example 1 investigated the effect of the water source on the accuracy of the methods described herein. In particular, the experiment studied whether the pH and chemical purity of water has any effect on the ability to accurately detect and measure the amount of poly-DADMAC in a water treatment system.

Poly-DADMAC was tagged with a fluorescent polymer marker detectable by fluorometry. Different amounts of the tagged poly-DADMAC were added to tap water to prepare treated tap water samples having known “added” active amounts of poly-DADMAC. Similarly, different amounts of the tagged poly-DADMAC were added to reverse osmosis feedwater to prepare treated RO water samples having known “added” active amounts of poly-DADMAC. Each of the tap water samples and RO water samples was observed by fluorometry using a probe (“original probe”) in order to determine the detectable amount of fluorescently tagged poly-DADMAC in the sample. The probe was capable of detecting up to 20 ppm active poly-DADMAC in the sample.

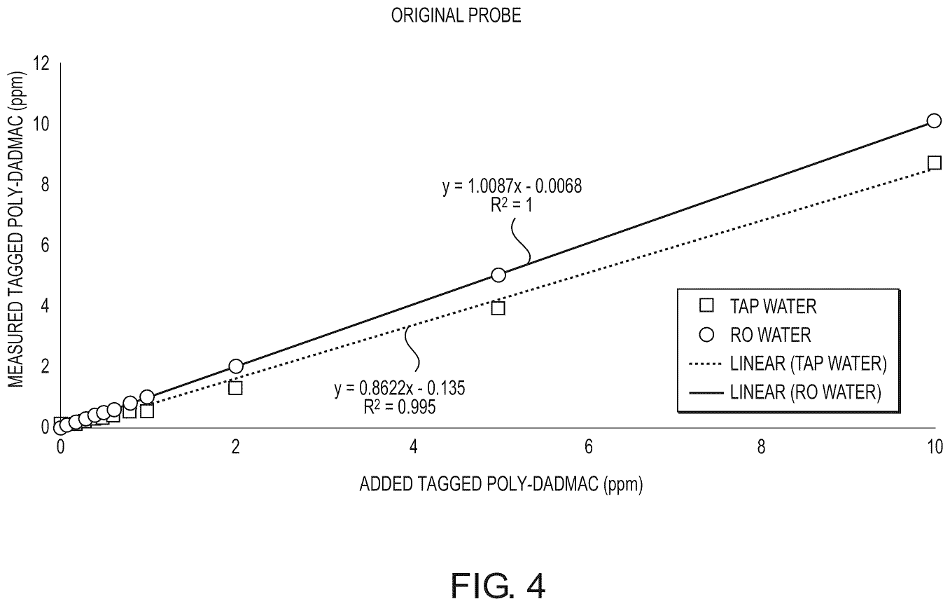

The added amount of tagged poly-DADMAC was compared to the measured amount of tagged poly-DADMAC in order to determine whether fluorometric reading of a fluorescently tagged poly-DADMAC can be used to accurately measure the active amount of poly-DADMAC in a sample. The pH was also measured for a variety of the samples at concentrations spanning from 0 ppm to 10 ppm. The results are summarized below in Table 1 (for RO water) and Table 2 (for tap water) below, and are shown in FIG. 4.

TABLE 1
RO water

| Added Tagged | Measured Tagged | |
|---|---|---|
| poly-DADMAC (ppm) | poly-DADMAC (ppm) | pH |
| 10 | 10.1 | 8.42 |
| 5 | 5.0 | 8.17 |
| 2 | 2.0 | — |
| 1 | 1.0 | 7.22 |
| 0.8 | 0.8 | — |
| 0.6 | 0.6 | — |
| 0.5 | 0.5 | 7.57 |
| 0.4 | 0.4 | — |
| 0.3 | 0.3 | 7.23 |
| 0.2 | 0.2 | — |
| 0.1 | 0.1 | — |
| 0 | 0.0 | 7.48 |

TABLE 2
tap water

| Added Tagged | Measured Tagged | |
|---|---|---|
| poly-DADMAC (ppm) | poly-DADMAC (ppm) | pH |
| 10 | 8.7 | 6.45 |
| 5 | 3.9 | — |
| 2 | 1.3 | — |
| 1 | 0.5 | 6.52 |
| 0.8 | 0.5 | — |
| 0.6 | 0.4 | — |
| 0.5 | 0.3 | — |
| 0.4 | 0.3 | — |
| 0.3 | 0.2 | 6.87 |
| 0.2 | 0.1 | — |
| 0.1 | 0.1 | — |
| 0 | 0.1 | 6.68 |

It was found that the fluorescent polymer probe reading could be successfully used to estimate the amount of actual active poly-DADMAC in a sample. The system was surprisingly effective when used with RO water, where near-perfect accuracy was observed. Without being bound by theory, it is believed that other ions already present in the tap water might have interfered to some degree with the ability to detect and quantify the fluorescent tag. The presence of these ions in the tap water might also explain why the RO water pH was more sensitive to the poly-DADMAC concentration.

### Example 2

The experiment of Example 2 investigated whether the concentration of poly-DADMAC could be accurately measured by fluorometry performed using a “low level probe.” The low level probe had a detection limit of up to 2 ppm active poly-DADMAC, with a higher sensitivity compared to the original probe used in Example 1.

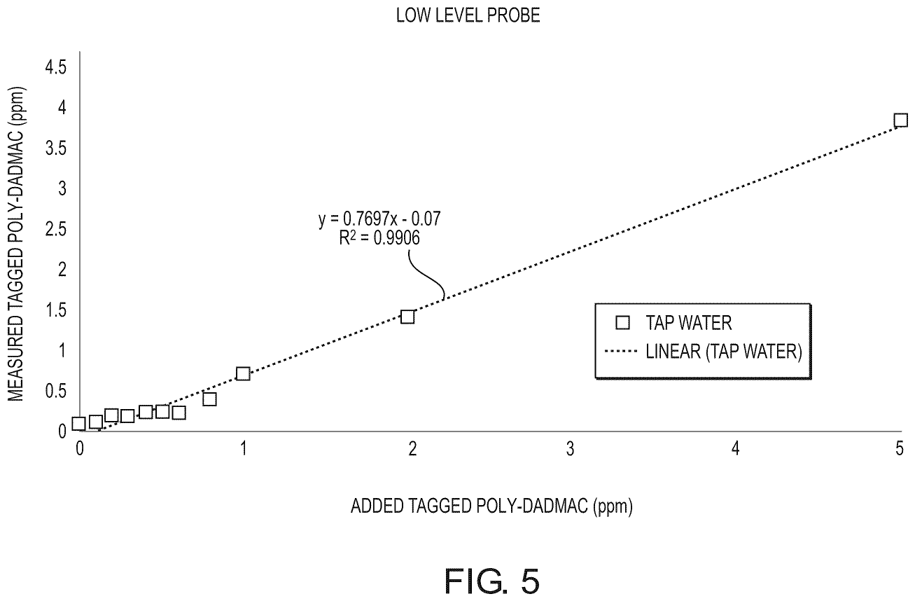

Samples having known “added” active amounts of poly-DADMAC were prepared according to the same procedure used in Example 1 using tap water. Each sample was observed by fluorometry using the low level probe in order to determine the detectable amount of fluorescently tagged poly-DADMAC in the sample. The added amount of tagger poly-DADMAC was compared to the measured amount of tagged poly-DADMAC in order to determine whether fluorometric reading of a fluorescently tagged poly-DADMAC can be used to accurately measure the active amount of poly-DADMAC in a sample. The results are summarized below in Table 3, and are shown in FIG. 5.

TABLE 3

| Added Tagged | Measured Tagged | |
|---|---|---|
| poly-DADMAC (ppm) | poly-DADMAC (ppm) | pH |
| 5 | 3.85 | 6.77 |
| 2 | 1.4 | 6.82 |
| 1 | 0.71 | 6.77 |
| 0.8 | 0.39 | 6.87 |
| 0.6 | 0.23 | 6.90 |
| 0.5 | 0.23 | 7.01 |
| 0.4 | 0.23 | 6.98 |
| 0.3 | 0.19 | 6.99 |
| 0.2 | 0.18 | 7.01 |
| 0.1 | 0.12 | 7.06 |
| 0 | 0.09 | 7.08 |

It was found that although the low level probe did not accurately measure the poly-DADMAC concentration over as wide a concentration range as the original probe used in Example 1, it was able to accurately detect and quantify the poly-DADMAC at very low concentrations typical of the maximum thresholds that are used in practice.

While the invention has been described in conjunction with specific exemplary embodiments thereof, it is evident that many alternatives, modifications, and variations will be apparent to those skilled in the art. Accordingly, exemplary embodiments of the invention as set forth herein are intended to be illustrative, not limiting. There are changes that may be made without departing from the spirit and scope of the invention.

What is claimed is:

1. A method of monitoring tagged poly(diallyldimethylammonium chloride) (poly-DADMAC) in a water treatment system, the method comprising:
adding an initial amount of the tagged poly-DADMAC into the water treatment system to obtain a target concentration of the tagged poly-DADMAC in the water treatment system; and
measuring a later concentration of the tagged poly-DADMAC in the water treatment system at a time after adding the initial amount of the tagged poly-DADMAC into the water treatment system.

2. The method of claim 1, wherein the measuring is performed continuously.

3. The method of claim 1, further comprising:
adding an additional amount of the tagged poly-DADMAC into the water treatment system if the measured later concentration of the tagged poly-DADMAC is less than the target concentration of the tagged poly-DADMAC.

4. The method of claim 2, further comprising:
adding an additional amount of the tagged poly-DADMAC into the water treatment system if the measured later concentration of the tagged poly-DADMAC is less than the target concentration of the tagged poly-DADMAC.

5. The method of claim 1, further comprising:
determining whether the measured later concentration of the tagged poly-DADMAC exceeds a predetermined threshold concentration of the tagged poly-DADMAC in the water treatment system; and
reducing or canceling a scheduled addition of an additional amount of the tagged poly-DADMAC into the water treatment system if the measured later concentration of the tagged poly-DADMAC is determined to exceed the predetermined threshold concentration of the tagged poly-DADMAC.

6. The method of claim 2, further comprising:
determining whether the measured later concentration of the tagged poly-DADMAC exceeds a predetermined threshold concentration of the tagged poly-DADMAC in the water treatment system; and
reducing or canceling a scheduled addition of an additional amount of the tagged poly-DADMAC into the water treatment system if the measured later concentration of the tagged poly-DADMAC is determined to exceed the predetermined threshold concentration of the tagged poly-DADMAC.

7. The method of claim 1, wherein the water treatment system is a membrane bioreactor.

8. The method of claim 1, wherein the water treatment system is:
(i) a reverse osmosis system; or
(ii) a component system of a reverse osmosis system selected from the group consisting of a multimedia filtration system, a microfiltration system, and an ultrafiltration system.

9. The method of claim 1, wherein the measuring is performed in situ.

10. A method of monitoring tagged poly(diallyldimethylammonium chloride) (poly-DADMAC) in a water treatment system, the method comprising:
continuously adding the tagged poly-DADMAC into the water treatment system at an initial position within the water treatment system;
continuously measuring a downstream concentration of the tagged poly-DADMAC at a downstream position within the water treatment system that is downstream of the initial position;
determining whether the measured downstream concentration of the tagged poly-DADMAC is above or below a predetermined threshold value; and
adjusting a concentration of the tagged poly-DADMAC being continuously added into the water treatment system according to whether the measured downstream concentration of the tagged poly-DADMAC is determined to be above or below the predetermined threshold value.

11. The method of claim 10, wherein the continuous measuring is performed in situ.

12. The method of claim 10, wherein the concentration of the tagged poly-DADMAC being continuously added into the water treatment system is adjusted by changing:
a flow rate at which the tagged poly-DADMAC is continuously added into the water treatment system; and/or
the concentration of the tagged poly-DADMAC being continuously added.

13. The method of claim 10, wherein the water treatment system is a membrane bioreactor.

14. The method of claim 10, wherein the water treatment system is:
(i) a reverse osmosis system; or
(ii) a component system of a reverse osmosis system selected from the group consisting of a multimedia filtration system, a microfiltration system, and an ultrafiltration system.

15. A method of monitoring a tagged organic coagulant polymer in a water treatment system, the method comprising:
continuously adding the tagged organic coagulant polymer into the water treatment system at an initial position within the water treatment system;
continuously measuring a downstream concentration of the tagged organic coagulant polymer at a downstream position within the water treatment system that is downstream of the initial position;
determining whether the measured downstream concentration of the tagged organic coagulant polymer is above or below a predetermined threshold value; and
adjusting a concentration of the tagged organic coagulant polymer being continuously added into the water treatment system according to whether the measured downstream concentration of the tagged organic coagulant polymer is determined to be above or below the predetermined threshold value.
